(19) United States
(12) Patent Application Publication
(10) Pub. No.: US 2012/0238319 A1
(43) Pub. Date: Sep. 20, 2012

(54) System and method for combined alarm detection and emergency signaling

(76) Inventor: Colin Patrick Lake, Carol Stream, IL (US)

(21) Appl. No.: 13/065,223

(22) Filed: Mar. 16, 2011

(51) Int. Cl. G08B 21/00; H04W 88/02

(52) U.S. Cl. 455/556.1; 340/663

(57) ABSTRACT

A system and method are provided for detecting emergency conditions and alerting a user while providing emergency lighting, using a combined alarm system. The system is connected to an external electrical power source to provide electrical power to the system, electrically charge an electrical energy storage, and provide ongoing detection of electrical power outages. When an alarm signal detector signaling device detects an external alarm signal, it generates an alternative alarm signal and a lighting source generates emergency lighting. When an abnormal voltage detector detects an electrical power outage, the lighting source included in the system generates emergency lighting. The user is able to carry the system as a portable source of emergency lighting, and control the generation of emergency lighting using an electrical power switch.

### BACKGROUND OF THE INVENTION

The present invention generally relates to alarm systems and methods for using such systems. More particularly, the present invention relates to systems that detect emergency alarm signals and emit alternative emergency alarm signals as well as emergency lighting, and methods for using such systems.

The vast majority of existing smoke detector units warn people of fires by emitting alarm signals in the form of loud sounds. However, for many individuals, auditory alarm signals may not provide sufficient warning. For example, 36 million American adults report suffering from hearing loss to some extent. In addition, 11 million American adults with hearing loss have specifically reported that they are unable to rely on the alarm signals emitted by a conventional smoke detector to provide warnings.

Several prior art systems and methods detect alarm signals emitted by smoke detectors or other emergency condition detectors and, in response, emit alternative alarm signals. The Lifetone HL Bedside Fire Alarm and Clock, with a user manual available at http://www.lifetonesafety.com/Files/Cache/file_6639.pdf, is one such system. The Lifetone HL is a bedside alarm device that uses a microphone to detect standardized smoke detector signals emitted by UL-listed T3 smoke detectors. Upon detection of a signal, the Lifetone HL emits a 520 Hz alarm sound signal from a speaker set in a single face of the device. Upon detection of a signal the Lifetone HL may also activate a Lifetone Bed Shaker. The Lifetone Bed Shaker vibrates which may provide a mechanical alarm when the Lifetone Bed Shaker has been placed under a pillow or mattress pad being used by a sleeping user.

Similarly, U.S. Pat. No. 7,173,525 to Albert discloses a fire, safety, security and health monitoring and alarm response method, system and device. In particular, Albert discloses a fire alarm detection method, which operates a bedside unit comprising a microphone for receiving sounds and a microprocessor for detecting alarm signals from an existing alarm device, such as a smoke detector. Upon detection, the bedside unit activates a separate waking device, which may emit alarm signals such as auditory alerts, light, or bed shaking motions.

U.S. Pat. No. 5,045,833 to Smith discloses an apparatus and system for alerting deaf persons. In particular, Smith discloses that to provide alerts, the device requires an external alerting device, such as “an electric table lamp or floor lamp,” plugged into the actuating device through a power outlet. Smith also discloses a microphone that detects the audio output frequency from a smoke detector, causing the actuating device to activate the alerting device.

U.S. Pat. No. 5,055,822 to Campbell discloses a scent alarm device. Campbell discloses a device that mechanically causes a spray canister to dispense an odorant as an alarm for some predetermined event. Campbell discloses that this device may “be interfaced with” a smoke detector, an electrical sensor “for indicating that household electrical power has been shut off,” or a burglar alarm, and that the device “is adapted to be energized upon the energizing of an electrical circuit with which the device [. . .] is interfaced,” though Campbell does not disclose the mechanisms of such interfacing or energizing. Campbell further discloses that this device also includes a “sound-generating means” and a standard incandescent bulb, both activated by said predetermined event.

U.S. Pat. No. 4,419,658 to Jaroz discloses a portable combination lamp, smoke detector and power failure alarm. Jarosz also discloses an internal smoke detecting sensor and a pulsed detector system. When smoke particles are detected as having entered the sensor, the detector system activates both the audible alarm device and the lamp.

U.S. Pat. No. 3,430,219 to Powers discloses a portable fire alarm that, upon detecting a fire, emits an auditory alarm, a visual alarm, and an odorous alarm. Powers discloses a fire detector that functions by releasing a series of weights when a seal is melted by heat, closing an electrical circuit for a siren and an electrical circuit for a pair of lamps, as well as breaking the enclosure that seals a receptacle containing an odorous substance.

U.S. Patent App. No. 2007/0216537 to Park discloses a system that includes a base unit and a silent alarm wristband. Park discloses that the base unit receives “wired or wireless sensor status [. . .] from a variety of sensors,” such as smoke alarms and carbon monoxide alarms, and that it sends wireless alarm signals to the silent alarm wristband that indicate the type of alarm sensed. Park further discloses that the silent alarm wristband delivers electric shocks in order to alert its wearer.

### BRIEF SUMMARY OF THE INVENTION

One or more of the embodiments of the present invention provide a user with a combined alarm system and a method for assisting a user in an emergency situation using said system. The system includes an electrical connection and electrical energy storage providing electrical power to the system, with the electrical energy storage being chargeable from electrical power received from the electrical connection. The system includes an alarm sensor and a microprocessor for detection of external alarm signals, an abnormal voltage detector for detection of electrical power outages, and an alarm signaling device for emitting alarms, an emergency light for providing emergency lighting, and an electrical power switch for controlling emergency lighting.

In operation, a user connects the electrical connection to an external electrical power source to provide electrical power to the system, charge the electrical energy storage, and detect electrical power outages. The system detects an external alarm signal on an ongoing basis by sensing stimuli such as sound using the alarm sensor, and processing those stimuli to identify alarm signals. When an external alarm signal is detected, the system activates the alarm signaling device to emit an alternative alarm signal, and activates the emergency light to provide lighting. When an electrical power outage is detected, the system activates the emergency light to provide lighting. When emergency lighting is provided, the user is able to carry the system as a portable source of illumination. Furthermore, when an electrical power outage occurs or the user is using the system portably, the system is electrically powered by the charge in its electrical energy storage.

### BRIEF DESCRIPTION OF THE DRAWINGS

FIG. 1 illustrates a combined alarm system according to an embodiment of the present invention.

FIG. 2 illustrates a front perspective view of the device housing of the combined alarm system of FIG. 1.

FIG. 3 illustrates a flow chart of an embodiment of the invention for a method of assisting a user in an emergency situation, using the combined alarm system of FIG. 1.

FIG. 4 illustrates a rear perspective view of the device housing of the combined alarm system of FIG. 1.

### DETAILED DESCRIPTION OF THE INVENTION

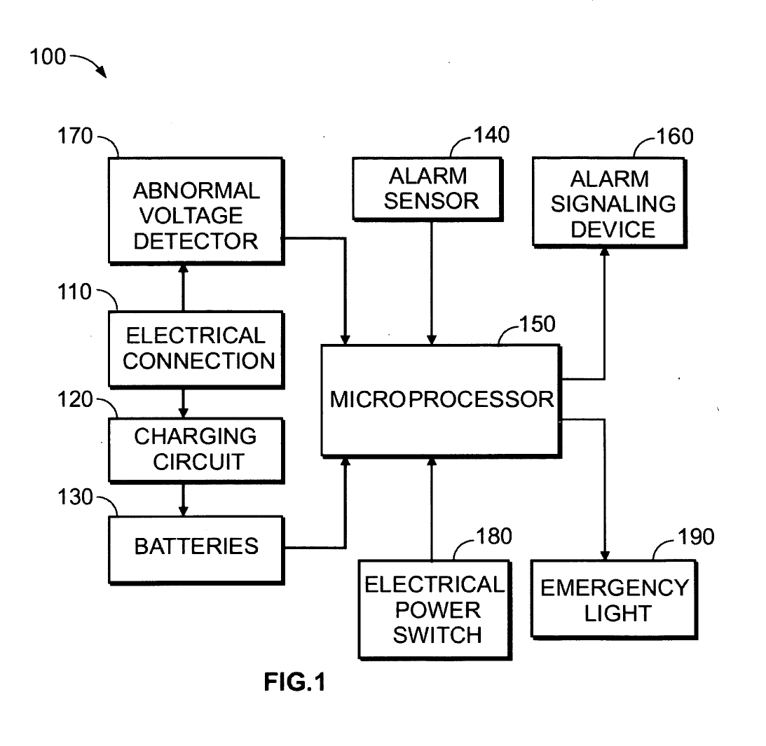

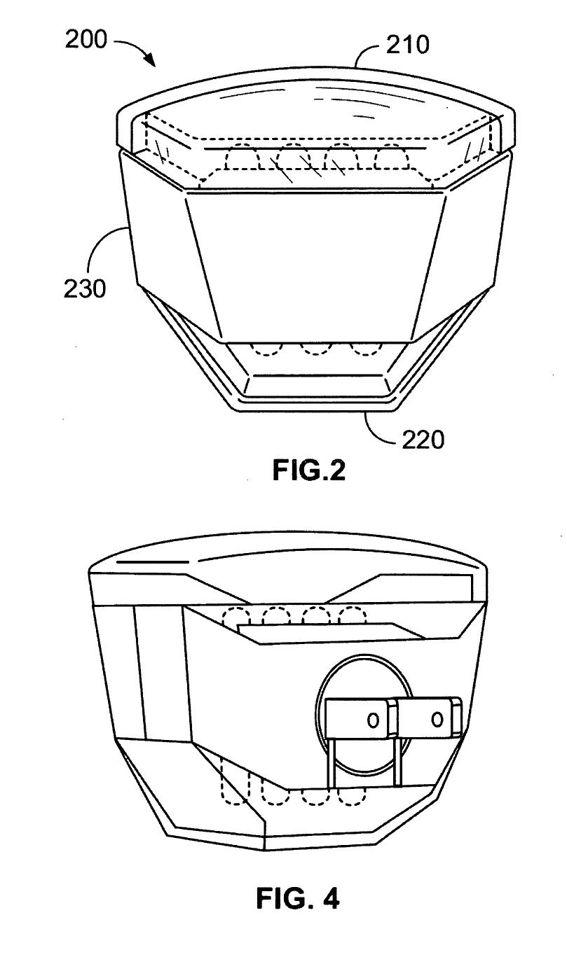

FIG. 1 illustrates a combined alarm system 100 that provides alarm detection and emergency signaling according to an embodiment of the present invention. The combined alarm system 100 includes an electrical connection 110, an electrical power charging circuit 120, an electrical energy storage/battery 130, an alarm sensor 140, a microprocessor 150, an alarm signaling device 160, an abnormal voltage detector 170, an electrical power switch 180, and a lighting source 190. These components of the combined alarm system 100 are preferably enclosed by a device housing 200 as shown in FIG. 2.

In the combined alarm system 100, the electrical connection 110 is electrically connected to the other parts of the combined alarm system 100 and allows electrical power to flow from the electrical connection 110 to the other parts of the combined alarm system 100. The electrical connection 110 is connected to the electrical energy storage 130 through the electrical power charging circuit 120, which allows electrical power to flow from the electrical connection 110 to the electrical energy storage 130. The electrical connection 110 is connected to the abnormal voltage detector 170 and allows electrical power to flow from the electrical connection 110 to the abnormal voltage detector 170. The electrical energy storage 130 is connected to the other parts of the combined alarm system 100 and allows electrical power to flow from the electrical energy storage 130 to the other parts of the combined alarm system 100.

The alarm sensor 140 is connected to the microprocessor 150. The microprocessor 150 is connected to the alarm signaling device 160. The microprocessor 150 is connected to the lighting source 190. The abnormal voltage detector 170 is connected to the microprocessor 150. The electrical power switch 180 is connected to the microprocessor 150.

In operation, the electrical connection 110 may be connected to an external electrical power source such as a standard wall outlet that provides a flow of electrical power. While the electrical connection 110 is connected to such an external electrical power source, electrical power flows from the external electrical power source through the electrical connection 110 to the other parts of the combined alarm system 100. While electrical power is flowing through the electrical power charging circuit 120 to the electrical energy storage 130, the electrical energy storage 130 is charged with electrical power.

Alternatively, in one embodiment the electrical connection 110 is connected to a wall outlet. When connected to the wall outlet, electrical power flows through the charging circuit 120 and into the batteries 130. Additionally, electrical power also flows through the abnormal voltage detector 170 to the microprocessor 150. Once the power is received at the microprocessor 150, the microprocessor 150 routes the power to the alarm sensor 140, alarm signaling device 160, and emergency light 190 in order to power those components as further described below.

On the other hand, when the electrical connection 110 is not connected to an external electrical power source such as a wall outlet that provides a flow of electrical power, if there is any electrical power stored in the batteries 130, then that electrical power flows from the batteries 130 to the microprocessor 150. Once received by the microprocessor 150, that power is then distributed to the components of the system similarly to power received from the wall outlet.

In the example of a power outage, the electrical connection 110 may be connected to a wall outlet, but no power is received. In this case, the abnormal voltage detector 170 detects the electrical power outage and communicates an electronic signal to the microprocessor 150 indicating an electrical power outage. The microprocessor 150 then powers itself using power received from the batteries 130. Further, the microprocessor 150 electronically activates the lighting source 190 and routes power received from the batteries 130 to the lighting source 190, so that the lighting source 190 emits light.

Further, the electrical power switch 180 may be used to switch the emergency light 190 on and off in this situation. For example, if the abnormal voltage detector 170 has detected a power outage and the microprocessor 150 has consequently caused the emergency light 190 to emit light, activation of the electrical power switch 180 causes the emergency light 190 to cease emitting light. However, if the power outage persists, further activation of the electrical power switch 180 causes the emergency light 190 to again begin to emit light.

Turning now to the alarm sensor, in operation the alarm sensor 140 receives external sensory stimuli from the environment outside the combined alarm system 100. For example, the alarm sensor 140 may be a micropohone that receives audible sounds. The alarm sensor 140 then generates an electronic signal representative of the audible sounds and sends the electronic signal to the microprocessor 150.

When the microprocessor 150 receives the electronic signal from the alarm sensor 140, the microprocessor 150 compares the sensory electronic signal to a reference stored on the microprocessor 150. When the electronic signal matches the reference, the microprocessor 150 sends an alarm instructing electronic signal to the alarm signaling device 160 that instructs the alarm signaling device 160 to emit an alternative alarm signal. Electrical power is also routed from the microprocessor 150 to the alarm signaling device 160 to provide power to allow the alarm signaling device to generate the alarm.

Further, when the received sensory electronic signal matches the reference signal, the microprocessor 150 sends a light instructing electronic signal to the lighting source 190 to instruct the lighting source 190 to emit light. Additionally, electrical power is provided from the microprocessor 150 to the lighting source 190. As described above, the lighting source may be switched on and off using the electrical power switch 180.

In a preferred embodiment, the electrical connection 110 is a power plug that plugs into an electrical outlet, such as an alternating current electrical outlet. In one embodiment, the electrical connection 110 is a collapsible rotating plug, where the prongs of the plug, when not plugged into an electrical outlet, are foldable into recessed slots in the body of the plug, and where, moreover, the body of the plug is recessed into the body of the device housing 200 of FIG. 2 and is installed on a base permitting the body of the plug to be rotated. This also permits the combined alarm system 100 to be physically rotated while the electrical connection 110 is connected to an electrical outlet. In another embodiment, the electrical connection 110 is a power plug attached to the device housing 200 by a flexible electrical power cord.

In some embodiments, the electrical connection 110 is replaced by a kinetic energy charger, where the kinetic energy charger receives kinetic energy when the combined alarm system 100 is carried or worn by a user or fastened or attached to a user's person, and where the kinetic energy charger generates electrical energy from kinetic energy received. While electrical energy is generated this way, it flows through the electrical power charging circuit 120 to the electrical energy storage 130, so that the electrical energy storage 130 is charged with electrical power.

In a preferred embodiment, the electrical energy storage 130 is rechargeable nickel-metal hydride cells. In other embodiments, the electrical energy storage 130 may be any other variety of rechargeable electrical energy storage.

In a preferred embodiment, the alarm sensor 140 is a microphone, where, in converting sound into a sensory electronic signal, the microphone outputs sound it receives as an audio input signal to an amplifier, which strengthens the audio input signal with a variable gain, generating an amplified audio input voltage. Additionally, in a preferred embodiment, in sending the sensory electronic signal to the microprocessor 150, the microphone sends the amplified audio input voltage to an input on the microprocessor 150.

In other embodiments, the alarm sensor 140 additionally detects the directionality of sound that it receives relative to itself, and describes this directionality as part of the sensory electronic signal that it sends to the microprocessor 150.

In a preferred embodiment, the microprocessor 150 is a Microchip 16F88 microprocessor. In a preferred embodiment, in comparing the sensory electronic signal to a reference stored on the microprocessor, the microprocessor 150 compares the amplified audio input voltage received at an input on the microprocessor 150 to a range of frequencies that a conventional smoke detector emits when detecting smoke due to a fire. Specifically, the microprocessor 150 sends the amplified audio input voltage to a comparator circuit, commonly referred to as a zero-crossing detection circuit, where the amplified audio input voltage is compared against a reference voltage.

The output of the comparator circuit is a square wave which is high when the amplified audio input voltage is above the reference voltage and is low, or ground, when the amplified audio input voltage is below the reference voltage. The output of the zero-crossing detection circuit is then fed into a capture circuit internal to the microprocessor, where the capture circuit interrupts the microprocessor 150 every time there is a rising edge in the output of the zero-crossing detection circuit.

The microprocessor computes the time elapsed between an interrupt caused by a previously detected rising edge and an interrupt caused by a current rising edge, and checks that the time elapsed falls within a range of 300 to 350 microseconds, which is a period of time corresponding to an input frequency of anywhere between approximately 2800 Hz to 3300 Hz, which is known to be the range of frequencies that a conventional smoke detector emits when detecting smoke due to a fire. If the microprocessor 150 detects such an input frequency, then the sensory electronic signal matches the reference.

In another embodiment, the microprocessor 150 may be any microprocessor of the Microchip PIC16F family. In another embodiment, the microprocessor 150 may be any microprocessor of the Microchip dsPIC30 or dsPIC33 family. In other embodiments, the microprocessor 150 may be any microprocessor whose architecture is able to execute a frequency-based detection mechanism to compare an electronic signal to a reference.

In other embodiments, the microprocessor 150 compares the output of the amplifier received at an input on the microprocessor 150 to a range of frequencies that a carbon monoxide detector emits when detecting carbon monoxide, a range of frequencies that an intruder alarm emits when detecting an intruder, or any number of other known frequency ranges of audible alarm signals emitted by particular types of alarms. In other embodiments, the microprocessor 150 may compare the output of the amplifier to multiple such frequency ranges, in parallel.

In a preferred embodiment, the microprocessor 150 has a General Purpose Input/Output Pin (“GPIO”) that has been programmed using pre-written software instructions, and the microprocessor 150 is connected to the alarm signaling device 160 and the lighting source 190 through this GPIO. In a preferred embodiment, the GPIO sends alarm instructing electronic signals and light instructing electronic signals to the alarm signaling device in accordance with the pre-written software instructions. In other embodiments, the microprocessor 150 determines the directionality of the sounds received by the alarm sensor 140, and, in the light instructing electronic signals that the microprocessor 150 sends to the lighting source 190, follows the pre-written software instructions to translate this directionality into instructions for selective light emission for multiple distinct arrays of LEDs to indicate directionality.

In a preferred embodiment, the alarm signaling device 160 is a first array of LEDs. In sending an alarm instructing electronic signal to the alarm signaling device 160, the microprocessor 150 activates the first array of LEDs, causing the first array of LEDs to emit light. Additionally, in a preferred embodiment, where the electrical connection 110 is be a collapsible rotating plug, if the electrical connection 110 is plugged into an electrical outlet set in a wall, the light emitted by the first array of LEDs may reflect off the wall, as well as nearby objects and surroundings, providing additional luminance and warning.

In some embodiments, the microprocessor 150 instructs the first array of LEDs to emit light in a strobe pattern or a blinking pattern. In another embodiment, the alarm signaling device is an audio speaker, where, in sending an alarm instructing electronic signal to the alarm signaling device 160, the microprocessor 150 instructs the speaker to vibrate to emit a certain sound. In another embodiment, the alarm signaling device is a tethered vibrator motor that can be placed on a level surface such as a nightstand or table, where, in sending an alarm instructing electronic signal to the alarm signaling device 160, the microprocessor 150 engages a pulse width modulation output circuit to drive the tethered vibrator motor to create vibrations on the surface on which the motor rests.

In another embodiment, the alarm signaling device is a cavity filled with an odorous liquid or gas, where, in sending an alarm instructing electronic signal to the alarm signaling device 160, the microprocessor 150 sends an electrical pulse that induces the cavity to change shape, discharging liquid or gas into the atmosphere. In other embodiments, the alarm signaling device 160 may be another device that emits a visible, audible, odorous, or tactile alarm signal when it receives a suitable alarm instructing electronic signal from the microprocessor 150. In other embodiments, the alarm signaling device 160 may be coupled in parallel to a combination of any of the alarm signaling devices described here.

In another embodiment, the alarm signaling device 160 comprises multiple distinct arrays of LEDs, each of a different color, wherein the multiple distinct arrays of LEDs may be instructed by light instructing electronic signals received from the microprocessor 150 to selectively emit light to indicate directionality. For example, a light instructing electronic signal may instruct one array of LEDs within the alarm signaling device 160, colored red to represent danger, to selectively emit light in the direction correlating to the directionality of the sensory electronic signal. At the same time, the same light instructing electronic signal may instruct another array of LEDs within the alarm signaling device 160, colored green to represent safety, to selectively emit light in the direction opposite to the directionality of the sensory electronic signal. In this way, the combined alarm system 100 illuminates a pattern of colored LEDs that visually shows a user the direction that an external sound has been received from by the alarm sensor 140, to aid escape in an emergency situation.

In a preferred embodiment, the electrical power switch 180 is a contact switch which is input to a pin on the microprocessor 150, where the microprocessor 150 measures transitions on the input pin, where each transition toggles the activation of the lighting source on or off on an alternating basis.

In a preferred embodiment, the lighting source 190 is a second array of LEDs. In other embodiments, the lighting source 190 may be any electrically powered light-emitting apparatus.

In yet another embodiment, the combined alarm system 100 is implemented as software executing on a smartphone. In this embodiment, the electrical connection 110 and the electrical power charging circuit 120 are combined as a smartphone charger that interfaces an external electrical power source and the smartphone. In this embodiment, the alarm sensor 140, microprocessor 150, alarm signaling device 160, and lighting source 190 are components of the smartphone, where the alarm sensor 140 is a microphone, the microprocessor 150 is a central processing unit, the alarm signaling device 160 is a speaker and an LCD screen, and the lighting source 190 is the LCD screen or an LED flash. In this embodiment, the electrical power switch 180 is a set of instructions coded into the software application that toggle the electrical flow to the LED flash through the internal electrical circuits. In some embodiments, the abnormal voltage detector 170 may be an external electronic module that connects to an external electrical power source, where the external electronic module is in unidirectional communication with the smartphone.

In this embodiment, a software application executing on the smartphone carries out electronic instructions directing the microphone to receive external sound and convert it to a sensory electronic signal, and directing the central processing unit to receive the sensory electronic signal and to compare it against a variety of known frequency ranges of audible alarm signals emitted by particular types of alarms. When known frequency ranges of audible alarm signals are detected, the software application also directs the microprocessor to send electronic instructions causing the speaker to emit audible alarm signals correlating to the known frequency ranges detected, causing the LCD screen to display visual alarm signals correlating to the known frequency ranges detected and also to emit light, and activating the LED flash to emit light. At this time, the software application provides a visual interface at the LCD screen that permits a user to interact with the LCD screen to toggle a switch displayed on the LCD screen, which directs the software application to toggle the activation of light emitted by the LCD screen and the LED flash. In some embodiments, when the external electronic module detects an electrical power outage, the external electronic module communicates a signal to the smartphone that is interpreted by the software application, whereupon the software application activates the LED flash to emit light.

FIG. 2 illustrates a front perspective view of the device housing 200 of the combined alarm system 100 of FIG. 1. FIG. 4 illustrates a rear perspective view of the device housing of the combined alarm system 100 of FIG. 1.

In a preferred embodiment, the device housing 200 includes a top light housing 210, a bottom light housing 220, and a light power actuator 230. In a preferred embodiment, the electrical connection 110 of FIG. 1 is installed on the back side of the device housing 200. In a preferred embodiment, the light power actuator 230 is a pushbutton. In other embodiments, the light power actuator 230 may be a toggle switch, or another physical device that applies force to actuate an electrical power switch.

In a preferred embodiment, the top light housing 210 is transparent and houses the alarm signaling device 160 of FIG. 1. In a preferred embodiment, the bottom light housing 220 is transparent and houses the lighting source 190 of FIG. 1. In a preferred embodiment, the light power actuator 230 is connected to the electrical power switch 180 of FIG. 1 and permits a user to manually actuate the electrical power switch 180 by applying pressure to the light power actuator 230.

In other embodiments, an attachment component is coupled to the device housing 200. In some embodiments, the attachment component may allow the combined alarm system 100, contained within the device housing 200, to be worn by a user. In these embodiments, the attachment component may take the form of a wrist strap, a bracelet band, a necklace strap, or any number of other conceivable apparatuses wearable by persons, and the device housing 200 may be shaped differently to complement the shape of the attachment component and to facilitate being worn on the body. In some embodiments, the attachment component may allow the combined alarm system 100, contained within the device housing 200, to be attached to an article of clothing or accessory worn by a user. In these embodiments, the attachment component may take the form of a clip, pin, strap, or any number of other conceivable apparatuses securely and removably attachable to pockets, belts, buttonholes, collars, lapels, sleeves, hat brims, backpacks, backpack straps, handbags, handbag straps, or any number of other articles of clothing or accessories worn by a user, and the device housing 200 and its components may be shaped differently to complement the shape of the attachment component and to facilitate being attached to an article of clothing or accessory.

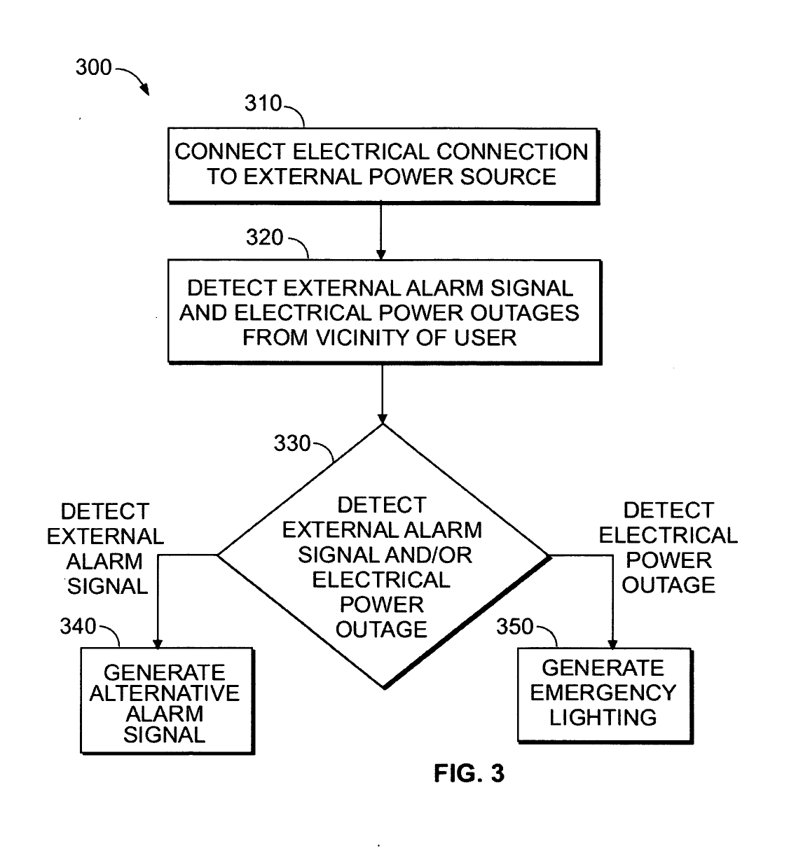

FIG. 3 illustrates a flow chart 300 for a method of assisting a user in an emergency situation, using the combined alarm system 100 of FIG. 1. First, in step 310, a user connects the electrical connection 110 of FIG. 1 of the combined alarm system 100 of FIG. 1 to an external electrical power source, whereupon the electrical connection 110 provides electrical power to the combined alarm system 100, and charges the electrical energy storage 130 of FIG. 1.

In a preferred embodiment, the external electrical power source is an electrical outlet, such as an alternating current electrical outlet. In a preferred embodiment, the user is able to use the combined alarm system 100 according to the method 300 at any location where local infrastructure provides for the availability of external electrical power sources and external alarm signaling devices, such as a home, hotel, or other place of temporary or long-term occupancy. In the occasion that external electrical power sources are not available but external alarm signaling devices are, the user is still able to use the combined alarm system 100 by pre-charging the system 100 so that the system 100 may be provided with operational power from its internal batteries 130.

Next, in step 320, the combined alarm system 100 of FIG. 1 is placed in the immediate vicinity of the user, where it attempts to detect an external alarm signal on an ongoing basis. If an external electrical power source is available, then the combined alarm system 100 is also able to detect electrical power outages at the external electrical power source as they occur while it is connected to the external electrical power source, and it is also able to receive electrical power and charge the electrical energy storage/batteries 130 of FIG. 1 while connected to the external electrical power source. If an external electrical power source is not available, then the combined alarm system 100 instead receives electrical power from the electrical energy storage 130 while detecting an external alarm signal on an ongoing basis.

In a preferred embodiment, the combined alarm system 100 is used to detect an external audible alarm signal emitted by a conventional smoke detector. In other embodiments, the combined alarm system 100 is used to detect an external audible alarm signal emitted by a carbon monoxide detector or an intruder alarm, or any number of other standard audible alarm signals emitted by alarm signaling devices. In other embodiments, the combined alarm system 100 may detect multiple such external audible alarm signals, in parallel, on an ongoing basis.

Next, in step 330, the system 100 attempts to detect an external alarm signal and/or an electrical power outage. When an external alarm signal is detected, the flowchart 300 proceeds to step 340. When an electrical power outage is detected, the flowchart 300 proceeds to step 350.

In step 340, the combined alarm system 100 generates an alternative alarm signal. In a preferred embodiment, the alternative alarm signal is an emission of light generated from a first array of LEDs. In a preferred embodiment, the emission of light generated from a first array of LEDs is controlled by the microprocessor 150 and electronically activated by alarm instructing electronic signals from the GPIO in accordance with programming by pre-written software instructions. In a preferred embodiment, the emission of light generated from a first array of LEDs has sufficient luminance to wake a user who is asleep while in the same room as the combined alarm system 100.

In some embodiments, the emission of light generated from a first array of LEDs occurs in a strobe or blinking pattern. In some embodiments, the first array of LEDs is colored differently so as to be distinguished from other sources of light included in the combined alarm system 100. In other embodiments, the alternative alarm signal may be a vibration motion generated from a vibrator, an odorous substance released from a cavity, or any number of other alternative alarm signals perceptible by users with hearing impairments.

In other embodiments, the combined alarm system 100 may proceed to other steps paralleling the procedure of step 340 when the combined alarm system 100 detects other external alarm signals or other emergency conditions. In such other steps, the combined alarm system 100 generates other alternative alarm signals different from the alternative alarm signal in step 340, corresponding to different external alarm signals and emergency situations.

In step 350, the combined alarm system 100 generates emergency lighting. In a preferred embodiment, the emergency lighting is an emission of light generated from a second array of LEDs. In a preferred embodiment, the emission of light generated from a second array of LEDs is controlled by the microprocessor 150 and electronically activated by light instructing electronic signals from the GPIO in accordance with programming by pre-written software instructions. In a preferred embodiment, the emission of light generated from a second array of LEDs is a continuous emission with sufficient luminance to provide indoor illumination during a nighttime electrical power outage.

In a preferred embodiment, the emission of light generated from a second array of LEDs is controlled by the electrical power switch 180, which is in turn controlled by a user applying force to the lighting power actuator 230.

In yet another embodiment, the method 300 may be performed using a combined alarm system implemented as software running on a smartphone, as previously described.

There are several disadvantages to the prior art systems and methods for detecting fires and other emergency conditions and emitting alternative alarm signals in response. First, many such prior art systems require an additional warning device in order to provide a warning signal. Albert and Smith disclose devices that work by controlling electrical power flow to existing, separate warning devices, rather than having built-in warning signal functionality.

Additionally, many such prior art systems disclose devices that are not portable, or, for example, may be placed on a surface, but must then be operated from a stationary position on the surface. The Lifetone HL, as well as the devices disclosed by Albert, are both devices that operate from a bedside positioning. Furthermore, Albert and Smith both disclose devices that are limited in mobility by a need to connect to another device in order to function.

Additionally, many such prior art systems disclose devices that use both standard electrical power sources and batteries, but do not draw electrical power from such power sources to charge their batteries. Albert and Smith both disclose devices that either do not use batteries or that do not contemplate charging backup batteries that they use.

In view of the preceding, it is evident that embodiments of the present invention provide a number of advantages over known systems and methods for detecting fires and other emergency conditions and emitting alternative alarm signals in response. The combined alarm system, without relying on external signaling devices, combines multiple types of alternative alarm signals in a single system that is also portable and backs up an external electrical power source with an internal rechargeable electrical energy storage.

Prior art systems include several undesirable limitations. For example, the Jarosz and Powers devices both disclose internal fire or smoke detectors; whereas Powers discloses an antiquated mechanical solution, and Jarosz discloses standard ionization chamber technology. However, neither of these solutions interacts with existing, external devices such as standard smoke detectors installed throughout a building. Conversely, the present combined alarm system is able to do so.

The disadvantage of relying on an internal detector is made more apparent in the context of the method disclosed by Jarosz. Jarosz discloses a method of using its alarm system in the context of travel: the device may be “placed in a [sic] operating condition in a hotel room” and plugged into a wall outlet. With respect to the smoke detection aspect of the Jarosz system the alarm devices included in the Jarosz system will be activated “should smoke enter the room” so as to alert the occupant of the room. However, waiting until smoke has entered the room before signaling an alarm decreases the occupant's chances of escaping safely. For this reason, many buildings contain building-wide systems of smoke detectors, and a personal alarm that interacts with such existing infrastructure will provide better chances for escape in an emergency.

The present combined alarm system builds upon this infrastructure in order to provide an alarm to a user more rapidly so as to give the user more time to react in case of fire, for example. That is, the user is likely to be safer when an in-room alarm is triggered based on the detection of an audible alarm emanating from down the hall—as opposed to waiting to trigger an alarm until there is actually smoke already in the user's room.

Additionally, the prior art systems that include multiple alarm devices do not have the ability to selectively activate individual alarm devices in response to different emergency conditions. In its preferred embodiment, the combined alarm system activates both alarm devices upon detecting an external alarm signal from a conventional smoke detector, but activates only the lighting source upon detecting an electrical power outage. Additionally, in a preferred embodiment, because both the first array of LEDs and the second array of LEDs are under software control, many options exist for their activation as well as emission in strobe or blinking patterns under any number of specific conditions, entirely within the discretion of the design of the software.

There are also disadvantages to the prior art emergency lights. In particular, Warhurst discloses an electrical power outage-detecting emergency light that detects no other emergency conditions. Furthermore, while some of the prior art alarm systems include emergency lights that illuminate upon detecting electrical power outages, some of these systems, such as the Campbell system, do not contemplate detecting both electrical power outages and other types of events at the same time. Other systems, such as the Jarosz system, detect both smoke and electrical power outages at once and illuminate emergency lights upon detection of either. However, even the Jarosz system does not disclose the use of programmable software to control the emergency lights, permitting a range of situational light outputs to be generated.

Additionally, most of the prior art systems covered above are not wearable or capable of being fastened or attached securely to a user's person. While the Park system is wearable, the alarm detection functions and alarm signaling options disclosed by Park are limited. Also, while the Jarosz system includes a clip, it is limited to attachment to stationary objects, which further limits the Jarosz system due to its reliance on an internal smoke detector, as already discussed. In this respect, the combined alarm system, in those embodiments that include an attachment component, overcomes these limitations by combining a more versatile combination of alarms and alarm detection in a housing that is wearable or attachable to a user's person.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A combined alarm system, said system comprising:
an alarm sensor;
an alarm signaling device;
an abnormal voltage detector; and
a first lighting source,
wherein when said alarm sensor detects an external alarm signal, said alarm sensor activates said alarm signaling device, causing said alarm signaling device to generate an alternative alarm signal, and said alarm sensor activates said first lighting source, causing said first lighting source to emit light, and
wherein when said abnormal voltage detector detects an electrical outage, said abnormal voltage detector activates said first lighting source, causing said first lighting source to emit light.

2. The system of claim 1, further including a rechargeable electrical energy storage;
wherein said rechargeable electrical energy storage retains electrical power while said combined alarm system is connected to an electrical power source that provides electrical power; and
wherein said rechargeable electrical energy storage provides electrical power to said combined alarm system when said combined alarm system is not connected to an electrical power source that provides electrical power.

3. The system of claim 2, wherein said combined alarm system is freely portable when not connected to an electrical power source.

4. The system of claim 3, further including an electrical power switch;
wherein toggling said electrical power switch toggles the emission of light from said lighting source.

5. The system of claim 1, further including a device housing and an attachment component;
wherein said combined alarm system is contained within said device housing; and
wherein said attachment component is coupled to the device housing.

6. The system of claim 5, wherein said attachment component is coupled to said device housing permanently.

4. The system of claim 5, wherein said attachment component is coupled to said device housing in a removable fashion.

5. The system of claim 5, wherein said attachment component, while coupled to said device housing, is wearable on a part of a human body.

6. The system of claim 5, wherein said attachment component, while coupled to said device housing, is removably attachable to an article of human clothing.

7. The system of claim 5, wherein said attachment component, while coupled to said device housing, is removably attachable to an accessory wearable on a human body.

8. The system of claim 1, wherein said alarm sensor is a microphone, and wherein said external alarm signal is an audible smoke detector signal.

9. The system of claim 8, wherein said combined alarm system further includes a microprocessor;
wherein said microprocessor cognizes and quantifies the directionality of said external alarm signals relative to said combined alarm system.

10. The system of claim 1, wherein said alarm signaling device is a second lighting source, and wherein said external alarm signal is a light emission.

11. The system of claim 10, wherein said second lighting source is an array of individual lights, and wherein said array of individual lights selectively emits light as directed by instructions sent by said alarm signal detector to indicate directionality of said external alarm signals relative to said combined alarm system.

12. The system of claim 11, wherein said second lighting source is a plurality of differently-colored arrays of individual lights, and wherein each array of individual lights selectively emits light independently as directed by instructions sent by said alarm signal detector.

13. The system of claim 1, wherein said alarm signaling device is an audio speaker, and wherein said external alarm signal is a sound emission.

14. The system of claim 1, wherein said alarm signaling device is a vibrator, and wherein said external alarm signal is a vibration motion.

15. The system of claim 1, wherein said alarm signaling device is a cavity containing an odorous substance, and wherein said external alarm signal is an atmospheric release of said odorous substance.

16. The system of claim 1, wherein said combined alarm system comprises a software application executed by a smartphone;
wherein said alarm signal detector is a microphone component of said smartphone;
wherein said alarm signaling device comprises at least one of a speaker component of said smartphone and an LCD screen component of said smartphone; and
wherein said abnormal voltage detector is an external electronic module connected to an external electrical power source, in unidirectional communication with said smartphone;
wherein said first lighting source comprises at least one of an LCD screen component of said smartphone and an LED flash component of said smartphone.

17. A method of detecting emergency conditions and alerting a user while providing emergency lighting, said method including:
connecting a combined alarm system to an electrical power source, wherein said combined alarm system includes an electrical energy storage that charges from said electrical power source;
detecting, at said combined alarm system, an external alarm signal;
detecting, at said combined alarm system, an electrical power outage;
generating, when said external alarm signal is detected at said combined alarm system, an alternative alarm signal;
generating, when said external alarm signal is detected at said combined alarm system, emergency lighting;
generating, when said electrical power outage is detected at said combined alarm system, emergency lighting powered from said electrical energy storage; and
providing said combined alarm system as a portable source of emergency lighting, powered by said electrical energy storage, when said combined alarm system is not connected to an electrical power source.

18. The method of claim 17, further including controlling said emission of light from using an electrical power switch.

19. The method of claim 17, wherein said combined alarm system is said combined alarm system of claim 1;
wherein detecting an external alarm signal is performed by said alarm signal detector of claim 1;
wherein detecting an electrical power outage is performed by said abnormal voltage detector of claim 1;
wherein generating an alternative alarm signal is performed by said alarm signaling device of claim 1; and
wherein generating emergency lighting is performed by said first lighting source of claim 1.

20. The method of claim 17, wherein said combined alarm system comprises a software application executed by a smartphone;
wherein detecting an external alarm signal is performed by a microphone component of said smartphone;
wherein detecting an electrical outage is performed by an external electronic module connected to said external electrical power source, in unidirectional communication with said smartphone;
wherein generating an alternative alarm signal is performed by at least one of a speaker component of said smartphone and an LCD screen component of said smartphone; and
wherein generating emergency lighting is performed by at least one of an LCD screen component of said smartphone and an LED flash component of said smartphone.
